(19) United States
(12) Patent Application Publication
(10) Pub. No.: US 2024/0123303 A1
(43) Pub. Date: Apr. 18, 2024

(54) Golf Club Cleaning Device

(71) Applicants: Jack Weiss, Las Vegas, NV (US); Todd Shelly, Las Vegas, NV (US)

(72) Inventors: Jack Weiss, Las Vegas, NV (US); Todd Shelly, Las Vegas, NV (US)

(21) Appl. No.: 18/484,489

(22) Filed: Oct. 11, 2023

Related U.S. Application Data
(60) Provisional application No. 63/415,359, filed on Oct. 12, 2022.

(51) Int. Cl. A63B 57/60; B08B 3/12

(52) U.S. Cl. CPC A63B 57/60; B08B 3/12

(57) ABSTRACT

The present invention relates to a golf club cleaning device. The device is comprised of an automatic golf club cleaning device that uses a generator and a transducer to ultrasonically clean golf clubs. More specifically, a user can place a golf club on a motorized sled within the device. Then, a user can press a button to lower the sled into a cleaning tank wherein the generator and the transducer ultrasonically clean the golf clubs.

### CROSS-REFERENCE TO RELATED APPLICATION

The present application claims priority to, and the benefit of, U.S. Provisional Application No. 63/415,359, which was filed on Oct. 12, 2022, and is incorporated herein by reference in its entirety.

### FIELD OF THE INVENTION

The present invention relates generally to the field of golf. More specifically, the present invention relates to a golf club cleaning device. The device is comprised of an automatic golf club cleaning device that uses a generator and a transducer to ultrasonically clean golf clubs. Accordingly, the present disclosure makes specific reference thereto. Nonetheless, it is to be appreciated that aspects of the present invention are also equally applicable to other like applications, devices, and methods of manufacture.

### BACKGROUND

Playing golf with dirty clubheads can affect the performance and longevity of the golf club. However, cleaning golf clubs is a tedious and time-consuming task that can lead to muscle fatigue from having to clean each club head. In addition, transporting dirty golf clubs can transfer unwanted dirt and debris into a vehicle or home.

Therefore, there exists a long-felt need in the art for a golf club cleaning device. More specifically, there exists a long-felt need in the art for a golf club cleaning device that can clean a plurality of golf club heads simultaneously. Further, there exists a long-felt need in the art for a golf club cleaning device that can clean a plurality of golf clubs simultaneously without requiring manual effort from the user. In addition, there exists a long-felt need in the art for a golf club cleaning device that uses a method of cleaning a golf club that is more thorough and faster than existing manual cleaning methods.

The subject matter disclosed and claimed herein, in one embodiment thereof, comprises a golf club cleaning device. The device is primarily comprised of a frame, a card reader, a cleaning tub, a club sled, and a covering comprised of a club door. The device can be used to clean at least one golf club in an automatic, ultrasonic manner via a generator and a transducer located in the cleaning tub. To use the device, a user places a golf club onto the club sled and secures the club to the sled via a clip. Then, a user presses a button wherein the sled moves downward into the cleaning tub wherein water, a cleaning solution, and the generator and transducer ultrasonically cleans the head/shaft of the golf club.

In this manner, the golf club cleaning device of the present invention accomplishes all the foregoing objectives and provides a golf club cleaning device that can clean a plurality of golf club heads simultaneously. Further, the device does so without requiring manual effort from the user. In addition, the ultrasonic cleaning that the device uses is more thorough and faster than existing manual cleaning methods.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a golf club cleaning device primarily comprised of a frame, a card reader, a cleaning tub, a club sled, and a covering comprised of a club door. The frame has an outer covering comprised of a metal or plastic material. The covering shields the inner components of the device from view. The covering is comprised of at least one service door that attaches to the frame and/or covering via at least one hinge. The door allows a user to access the inner components of the device for repairs/maintenance purposes. The covering is also comprised of at least one club door that can be opened to allow a user to insert at least one golf club into the device during use.

Once inserted into the device, a golf club is secured within the device to at least one clip attached to at least one sled. The sled is preferably a motorized sled that moves up and down in the vertical direction to raise and lower golf clubs into a cleaning tub positioned within the device. The golf club is cleaned by being lowered by the sled into the cleaning tub wherein the tub is comprised of at least one generator and at least one transducer. The generator converts electrical energy from the battery into mechanical energy in the form of sound waves that produce cavitation to clean the golf club (and more specifically, the head of the golf club). Together with the generator, the transducer produces a frequency that is preferably at least 40 kHZ to ultrasonically clean the golf club.

During the cleaning process, water and a cleaning solution (of any combination/concentration) fill in the tub. The cleaning solution may be comprised of any ultrasonic and/or golf club cleaning solution known in the art. The water and solution are stored in a water reservoir and a cleaning solution reservoir.

To use the device, a user can pay via at least one credit card reader of any type known in the art. Once a user has paid, they can place at least one club into the device and secure the club to the clip of the sled. The door can then be closed and a button on the exterior of the device can be pressed to begin the cleaning cycle.

The present invention is also comprised of a method of using the device. First, a device is provided comprised of a frame, a cleaning tub comprised of a generator and transducer, a club sled comprised of a clip, and a covering comprised of a club door. Then, a user can open the club door and insert at least one golf club into the device and secure said golf club to the clip of the sled. Then, the user can close the club and press a button to begin the cleaning cycle. After the cleaning cycle has been completed, the user can open the club door and remove the cleaned club from the clip.

Accordingly, the golf club cleaning device of the present invention is particularly advantageous as it provides a golf club cleaning device that can clean a plurality of golf club heads simultaneously. Further, the device does so without requiring manual effort from the user. In addition, the ultrasonic cleaning that the device uses is more thorough and faster than existing manual cleaning methods. In this manner, the golf club cleaning device overcomes the limitations of existing methods of cleaning golf clubs known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a frame of one potential embodiment of a golf club cleaning device of the present invention in accordance with the disclosed architecture;

FIG. 2 illustrates a front view of one potential embodiment of a golf club cleaning device of the present invention in accordance with the disclosed architecture;

FIG. 3 illustrates a perspective view of an interior space of one potential embodiment of a golf club cleaning device of the present invention in accordance with the disclosed architecture;

FIG. 4 illustrates a front view of an interior space of one potential embodiment of a golf club cleaning device of the present invention in accordance with the disclosed architecture; and

FIG. 5 illustrates a flowchart of a method of using one potential embodiment of a golf club cleaning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a golf club cleaning device. More specifically, there exists a long-felt need in the art for a golf club cleaning device that can clean a plurality of golf club heads simultaneously. Further, there exists a long-felt need in the art for a golf club cleaning device that can clean a plurality of golf clubs simultaneously without requiring manual effort from the user. In addition, there exists a long-felt need in the art for a golf club cleaning device that uses a method of cleaning a golf club that is more thorough and faster than existing manual cleaning methods.

The present invention, in one exemplary embodiment, is comprised of a golf club cleaning device primarily comprised of a frame, a card reader, a cleaning tub, a club sled, and a covering comprised of a club door. The frame has an outer covering comprised of a metal or plastic material that shields the inner components of the device from view. The covering is comprised of at least one service door that attaches to the frame and/or covering via at least one hinge. The door allows a user to access the inner components of the device for repairs/maintenance purposes. The covering is also comprised of at least one club door that can be opened to allow a user to insert at least one golf club into the device during use.

Once inserted into the device, a golf club is secured within the device to at least one clip attached to at least one sled. The sled is preferably a motorized sled that moves up and down in the vertical direction to raise and lower golf clubs into a cleaning tub positioned within the device. The golf club is cleaned by being lowered by the sled into the cleaning tub wherein the tub is comprised of at least one generator and at least one transducer. The generator converts electrical energy from the battery into mechanical energy in the form of sound waves that produce cavitation to clean the golf club (and more specifically, the head of the golf club). Together with the generator, the transducer produces a frequency that is preferably at least 40 kHZ to ultrasonically clean the golf club.

During the cleaning process, water and a cleaning solution (of any combination/concentration) fill in the tub. The cleaning solution may be comprised of any ultrasonic and/or golf club cleaning solution known in the art. The water and solution are stored in a water reservoir and a cleaning solution reservoir.

To use the device, a user can pay via at least one credit card reader of any type known in the art. Once a user has paid, they can place at least one club into the device and secure the club to the clip of the sled. The door can then be closed and a button on the exterior of the device can be pressed to begin the cleaning cycle.

The present invention is also comprised of a method of using the device. First, a device is provided comprised of a frame, a cleaning tub comprised of a generator and transducer, a club sled comprised of a clip, and a covering comprised of a club door. Then, a user can open the club door and insert at least one golf club into the device and secure said golf club to the clip of the sled. Then, the user can close the club and press a button to begin the cleaning cycle. After the cleaning cycle has been completed, the user can open the club door and remove the cleaned club from the clip.

Accordingly, the golf club cleaning device of the present invention is particularly advantageous as it provides a golf club cleaning device that can clean a plurality of golf club heads simultaneously. Further, the device does so without requiring manual effort from the user. In addition, the ultrasonic cleaning that the device uses is more thorough and faster than existing manual cleaning methods. In this manner, the golf club cleaning device overcomes the limitations of existing methods of cleaning golf clubs known in the art.

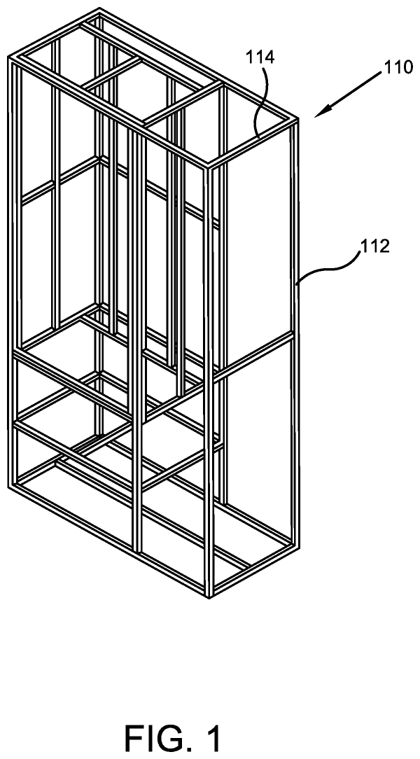

Referring initially to the drawings, FIG. 1 illustrates a perspective view of a frame of one potential embodiment of a golf club cleaning device 100 of the present invention in accordance with the disclosed architecture. The device 100 is primarily comprised of a frame 110, a card reader 150, a cleaning tub 160, a club sled 170, and a covering 120 comprised of a club door 140. The frame 110 of the device 100 is preferably rectangular in shape and made from a durable metal material such as, but not limited to, aluminum. The frame 110 provides structural support to the device 100 via at least one vertical frame member 112 and at least one horizontal frame member 114.

The frame 110 has an outer covering 120. The covering 120 is secured to the frame 110 via fasteners or other attachment mechanisms of the like. The covering 120 may be comprised of a metal or plastic material. The covering 120 shields the inner components of the device 100 from view.

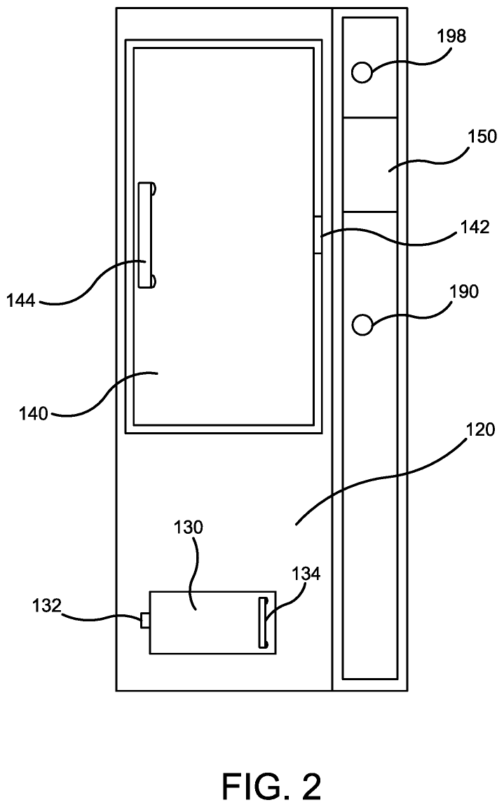

The covering 120 is comprised of at least one service door 130 that attaches to the frame 110 and/or covering via at least one hinge 132, as seen in FIG. 2. The hinge 132 may be of any hinge type known in the art. The door 130 allows a user to access the inner components of the device 100 for repairs/maintenance purposes. The door 130 may be comprised of at least one locking handle 134 of any type known in the art.

Similarly, the covering 120 is comprised of at least one club door 140. The door 140 connects to the frame 110 and/or covering 120 via at least one hinge 142 (of any hinge type known in the art). The club door 140 may be comprised of at least one handle 144 that is preferably any type of locking handle known in the art. The club door 140 can be opened to allow a user to insert at least one golf club 10 into the device 100 during use.

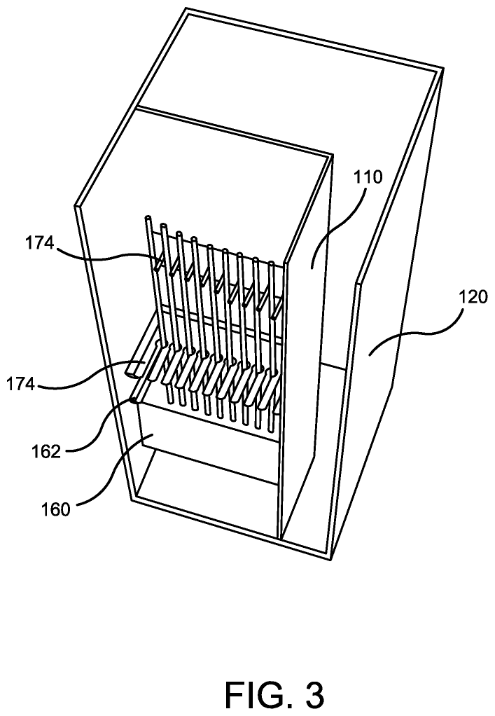

More specifically, at least one golf club 10 can be inserted into the device 100 via the door 140 and secured within the device 100 to at least one clip 174 attached to at least one sled 170, as seen in FIG. 3. The sled 170 is preferably a motorized sled 170 that moves up and down in the vertical direction to raise and lower golf clubs 10 into a cleaning tub 160 positioned within the device 100. The sled 170 preferably moves up/down on at least one motorized track 172 powered by at least one battery 192 of the device 100.

The golf club 10 is cleaned by being lowered by the sled 170 into the cleaning tub 160. The tub 160 is preferably made from a stainless-steel material. When not in use, the tub 160 is covered by a motorized lid 162 that retracts to expose the tub 160 when the sled 170 begins to move downward, thus allowing the club 10 to be inserted into the tub 160.

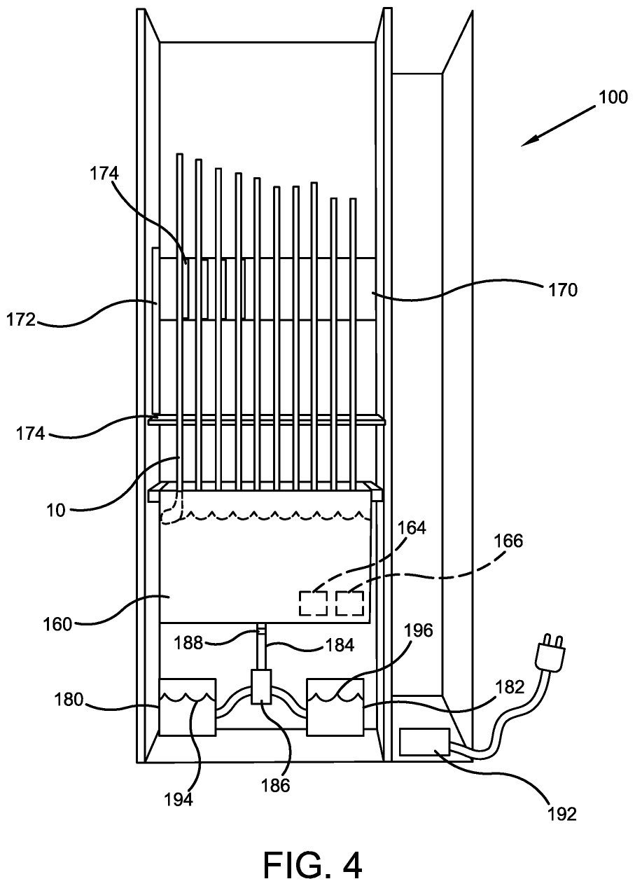

The tub 160 is comprised of at least one generator 164 and at least one transducer 166, as seen in FIG. 4. The generator 164 may be any type of power generator known in the art that converts electrical energy from the battery 192 into mechanical energy in the form of sound waves that produce cavitation to clean the golf club (and more specifically, the head of the golf club 10). Together with the generator 164, the transducer 166 produces a frequency that is preferably at least 40 kHZ to ultrasonically clean the golf club 10. The cleaning cycle preferably lasts for at least 90 seconds. However, the cleaning cycle may vary in different embodiments.

During the cleaning process, water 194 and a cleaning solution 196 (of any combination/concentration) fill in the tub 160. The cleaning solution 196 may be comprised of any ultrasonic and/or golf club cleaning solution known in the art. The water 194 and solution 196 are stored in a water reservoir 180 and a cleaning solution reservoir 182, respectively. Both reservoirs 180,182 are in fluid communication with the tub 160 via at least one piece of tubing 184. The tubing 184 may be comprised of at least one filter 188 to prevent debris from back flowing into each reservoir 180,182 after the golf club 10 has been cleaned. The water 194 and solution 196 may be pumped into the tub 160 via at least one pump 186 of any type known in the art.

To use the device 100, a user can pay via at least one credit card reader 150 of any type known in the art. Once a user has paid, they can place at least one club 10 into the device 100 and secure the club 10 to the clip 174 of the sled 170. The door 140 can then be closed and a button 190 on the exterior of the device 100 can be pressed to begin the cleaning cycle. The device 100 may have at least one LED light 198 that illuminates a first color when the cleaning cycle is occurring and that illuminates a second color when the cleaning cycle is finished to indicate to the user that they can retrieve their club 10 from the device 100.

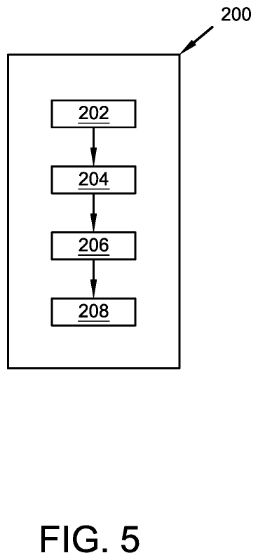

The present invention is also comprised of a method of using the device 100, as seen in FIG. 5. First, a device 100 is provided comprised of a frame 110, a cleaning tub 160 comprised of a generator 164 and transducer 166, a club sled 170 comprised of a clip 174, and a covering 120 comprised of a club door 140 [Step 202]. Then, a user can open the club door 140 and insert at least one golf club 10 into the device 100 and secure said golf club to the clip 174 of the sled [Step 204]. Then, the user can close the club door 140 and press a button 190 to begin the cleaning cycle [Step 206]. After the cleaning cycle has been completed, the user can open the club door 140 and remove the cleaned club 10 from the clip 174 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “golf club cleaning device” and “device” are interchangeable and refer to the golf club cleaning device 100 of the present invention.

Notwithstanding the foregoing, the golf club cleaning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the golf club cleaning device 100 as shown in the FIGS. are for illustrative purposes only, and that many other sizes and shapes of the golf club cleaning device 100 are well within the scope of the present disclosure. Although the dimensions of the golf club cleaning device 100 are important design parameters for user convenience, the golf club cleaning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A golf club cleaning device comprising:
a frame;
a covering;
a door;
a cleaning tub;
a generator;
a transducer;
a sled comprised of a clip;
a pump; and
a button.

2. The golf club cleaning device of claim 1, wherein the generator is positioned within the cleaning tub.

3. The golf club cleaning device of claim 1, wherein the transducer is positioned within the cleaning tub.

4. The golf club cleaning device of claim 1, wherein the door is comprised of a locking handle.

5. The golf club cleaning device of claim 1, wherein the cleaning tub is comprised of a stainless-steel cleaning tub.

6. The golf club cleaning device of claim 1 further comprising a battery that powers the generator and the transducer.

7. A golf club cleaning device comprising:
a frame;
a covering attached to the frame;
a door attached to the covering via a hinge;
a cleaning tub;
a generator;
a transducer;
a water reservoir;
a cleaning solution reservoir;
a sled comprised of a clip, the sled attached to a motorized track;
a pump;
a button; and
an LED light.

8. The golf club cleaning device of claim 7, wherein the transducer is comprised of a 40 kHZ transducer.

9. The golf club cleaning device of claim 7, wherein the cleaning tub is comprised of a motorized lid.

10. The golf club cleaning device of claim 7, wherein the LED light illuminates a first color and a second color.

11. The golf club cleaning device of claim 7 further comprising a credit card reader.

12. The golf club cleaning device of claim 7, wherein the sled can move vertically on the motorized track.

13. The golf club cleaning device of claim 7 further comprising a cleaning solution.

14. The golf club cleaning device of claim 7 further comprising a battery that powers the generator, the transducer, the pump and the motorized track.

15. The golf club cleaning device of claim 7 further comprising a tubing that places the water reservoir and the cleaning solution reservoir in fluid communication with the cleaning tub.

16. The golf club cleaning device of claim 15, wherein the tubing is comprised of a filter.

17. The golf club cleaning device of claim 7, wherein the generator is positioned within the cleaning tub.

18. The golf club cleaning device of claim 7, wherein the transducer is positioned within the cleaning tub.

19. A method of using a golf club cleaning device, the method comprising the steps of:
providing a golf club cleaning device comprised of a frame, a cleaning tub comprised of a generator and transducer, a club sled comprised of a clip, and a covering comprised of a club door;
inserting a golf club into the device;
securing the golf club to the clip of the sled;
closing the club door;
pressing a button to begin a cleaning cycle of the golf club cleaning device; and
removing the golf club from the clip after the cleaning cycle has ended.

20. The method of claim 19, wherein the club sled is comprised of a motorized track.
